(19) United States
(12) Patent Application Publication
(10) Pub. No.: US 2016/0069991 A1
(43) Pub. Date: Mar. 10, 2016

(54) APPARATUS AND METHOD FOR BEACON PROCESSING

(71) Applicant: QUALCOMM Incorporated, San Diego, CA (US)

(72) Inventors: Saumitra Mohan Das, Santa Clara, CA (US); Faraz Mohammad Mirzaei, San Jose, CA (US); Ayman Fawzy Naguib, Cupertino, CA (US)

(21) Appl. No.: 14/479,126

(22) Filed: Sep. 5, 2014

(51) Int. Cl. G01S 11/02

(52) U.S. Cl. CPC G01S 11/02

(57) ABSTRACT

Systems, apparatus and methods for determining a beacon device are presented. A device selects a beacon device by computing travelling distances between a mobile device and respective locations for a plurality of beacon devices. The selected beacon device may be the beacon device the mobile device would reach first and may consider a course of the mobile device and what type of services are offered and needed from a particular beacon device.

### BACKGROUND

I. Field of the Invention

This disclosure relates generally to systems, apparatus and methods for beacon signal processing, and more particularly to sorting and/or selecting one or more wireless beacon devices based, at least in part, on a navigable distance corresponding to location of a mobile device.

II. Background

A “line-of-sight” distance, either a received signal strength indication (RSSI) or a round-trip time (RTT), is often used to determine which beacon device is “closest” to a user. A line-of-sight distance does not necessarily means a beacon device is insight. A closest beacon device, in terms of a line-of-sight beacon device, may not necessarily be a first beacon a user reaches during a journey through an office building, store or the like in a venue presenting several beacon devices. What is needed is a way to determine a beacon device that a mobile device would reach first if navigating to each of several beacon devices.

### BRIEF SUMMARY

Disclosed are systems, apparatus and methods a device, such as a mobile device or server, to select a beacon device. A beacon device may be selected based on navigable distance (e.g., a machine travelling distance, a user-travelling distance, user walking distance, or the like) between the mobile device and various beacon devices. One or more beacon devices may be selected based on a navigable distance between a user or a machine carrying or otherwise comprising the mobile device and the beacon devices. A selected beacon device may not necessarily a beacon device offering a strongest signal (e.g., with the highest RSSI) or a closest beacon device (e.g., with the lowest RTT) but rather a beacon device that suites a particular purpose, for example, is in front of the user and/or not blocked by walls and/or doors, etc.

According to some aspects, disclosed is a device for selecting a beacon device, the device comprising: a transceiver configured to receive a graph; and a processor coupled to the transceiver and configured to compute travelling distances between a location of a mobile device and respective locations of a plurality of beacon devices based, at least in part, on the graph; and configured to select one or more of the beacon devices based, at least in part, on one or more of the computed travelling distances.

According to some aspects, disclosed is a method for determining a beacon device, the method comprising: receiving a graph; computing travelling distances between a location of a mobile device and respective locations of a plurality of beacon devices based, at least in part, on the graph; and selecting one or more of the beacon devices based, at least in part, on one or more of the computed travelling distances.

According to some aspects, disclosed is a device for determining a beacon device, the device comprising: means for receiving a graph; means for computing travelling distances between a location of a mobile device and respective locations of a plurality of beacon devices based, at least in part, on the graph; and means for selecting one or more of the beacon devices based, at least in part, on one or more of the computed travelling distances.

According to some aspects, disclosed is a non-transient computer-readable storage medium including program code stored thereon, comprising program code for: receiving a graph; computing travelling distances between a location of a mobile device and respective locations of a plurality of beacon devices based, at least in part, on the graph; and selecting one or more of the beacon devices based, at least in part, on one or more of the computed travelling distances.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIG. 1 illustrates example “line-of-sight” distances (d₁ and d₂) from a mobile device to a plurality of beacon devices.

FIG. 2 shows how example travelling distances (d₃ and d₄) differ from example line-of-sight distances when a wall separates a mobile device from one or more of the plurality of beacon devices.

FIGS. 3-5 show a mobile device, line-of-sight distances, travelling distances and several beacon devices on an example floor plan.

FIGS. 6 and 7 illustrate a mobile device, in accordance with some example embodiments.

FIGS. 8 and 9 illustrate methods for use in a mobile device, in accordance with some example embodiments.

FIGS. 10, 11 and 12 illustrate methods for determining a beacon device, in accordance with some example embodiments.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, GLONASS or Compass may transmit a signal marked with a PN code that is distinguishable from PN codes transmitted by other SVs in the constellation (e.g., using different PN codes for each satellite as in GPS or using the same code on different frequencies as in GLONASS). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, a mobile device, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device.”

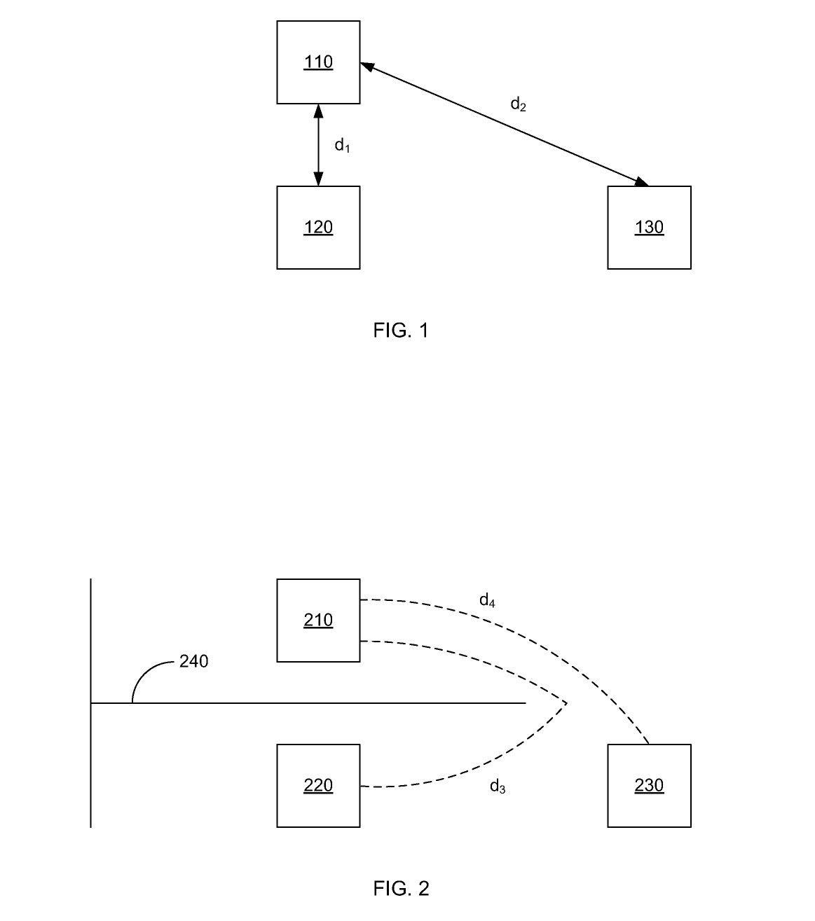

FIG. 1 illustrates example “line-of-sight” distances (d₁ and d₂) from a mobile device 110 to a plurality of beacon devices (e.g., beacon devices 120 and 130). A beacon device may be a Bluetooth beacon device, such as a low energy beacon device, also known as Bluetooth low energy, Bluetooth LE or BLE, a “classic” Bluetooth beacon device, or a WiFi access point and may be referred to as a transceiver, which is remote from a mobile device 110. To determine which beacon device is closest, signal strengths or round-trip times received at the mobile device 110 tell the mobile device 110 that beacon device 120 is at a distance of d₁ and beacon device 130 is at a distance of d₂. In this case, distance d₁ is less than distance d₂. Therefore, beacon device 120 appears closer than beacon device 130.

FIG. 2 shows how example travelling distances (d₃ and d₄) differ from example line-of-sight distances when a wall 240 separates a mobile device 210 from one or more of the plurality of beacon devices (e.g., beacon devices 220 and 230). A user of the mobile device 210 travels distance d₃ to beacon device 220 and distance d₄ to beacon device 230. Because of a wall 240 separating the mobile device 210 from beacon device 220, the user must pass beacon device 230 before reaching beacon device 220. Even though the line-of-sight distance d₁ is less than the line-of-sight distance d₂, in the case the travelling distance d₃ is more than the travelling distance d₄. Therefore, beacon device 230 is “closer” than beacon device 220 to the mobile device 210.

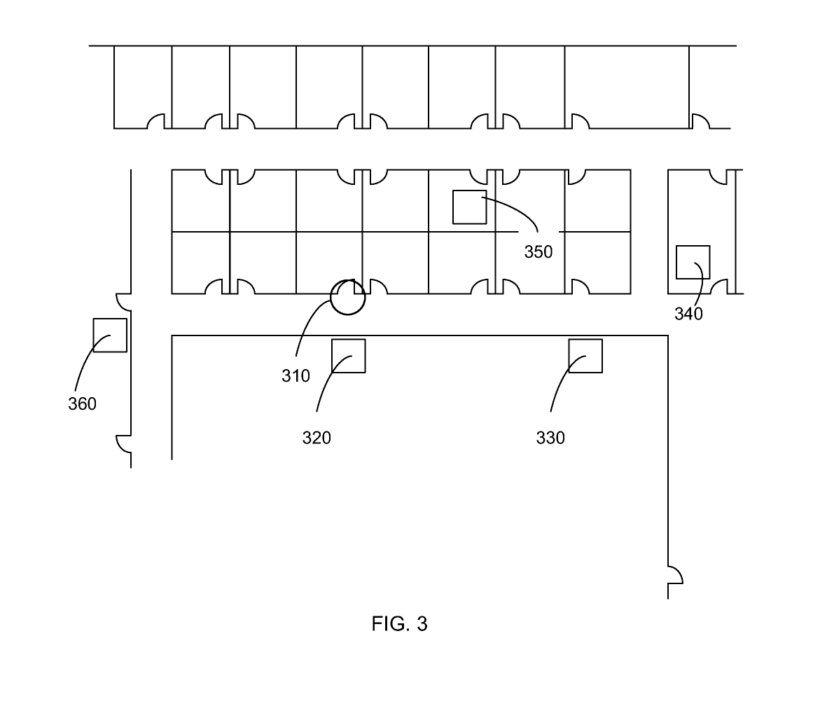

FIGS. 3-5 show a mobile device, line-of-sight distances, travelling distances and several beacon devices on an example floor plan.

In FIG. 3, a circle indicates mobile device 310 and squares indicate beacon device 320, beacon device 330, beacon device 340, beacon device 350 and beacon device 360. Assuming all beacon devices transmit with at a common power level or that the transmit power level for individual beacon devices may be known or determinable, the mobile device 310 may determine indications of signal power strength, referred to as received signal strength indication or RSSI, corresponding to each beacon device. An RSSI measurement may be used (with known techniques) to determine an approximate line-of-sight distance between the transmitting device's antenna and the mobile device's antenna. An RSSI measurement from beacon device 320 may indicate that beacon device 320 is closer when compared with an RSSI measurement from beacon device 340. That is, from a perspective of the mobile device 310, a line-of-sight distance from beacon device 320 is less than a line-of-sight distance from beacon device 340.

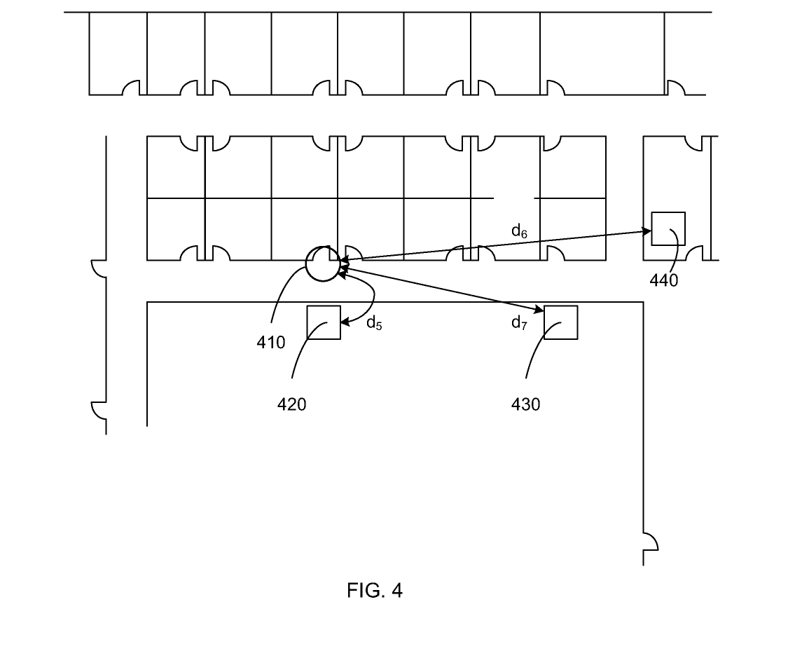

In FIG. 4, a line-of-sight distance to a mobile device 410 from each beacon device 420, 430 and 440 are shown as distance d₅, d₆ and d₇, respectively. In this case, line-of-sight distance d₅ is less than d₇ is less than d₆.

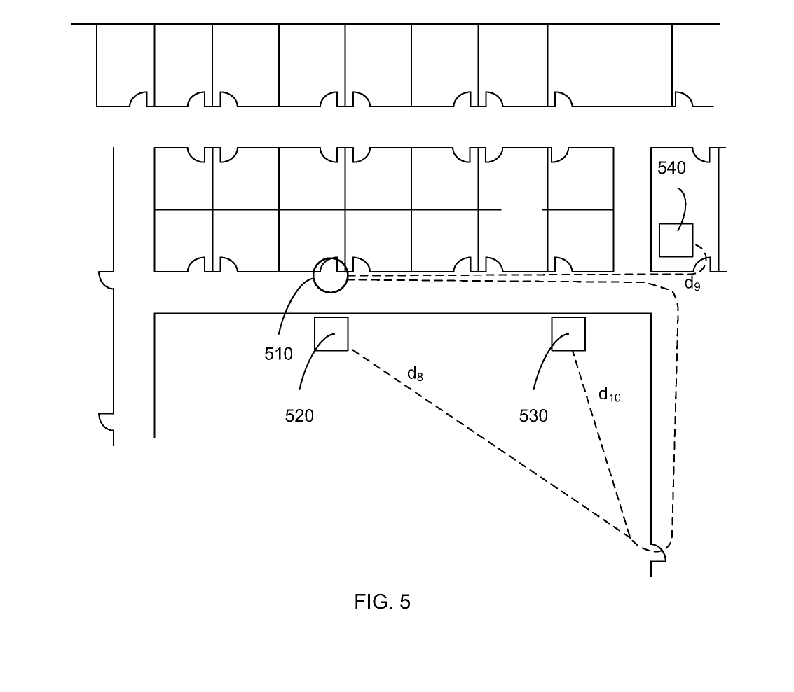

In FIG. 5, a travelling distance from a mobile device 510 to each beacon device 520, 530 and 540 are shown as distance d₈, d₉ and d₁₀, respectively. In this case, a user of the mobile device 510 passes beacon device 540 and beacon device 530 before reaching beacon device 520, which may be erroneously considered “closest” if considering RSSI measurements. Here, the travelling distance d₉ is less than d₁₀ is less than d₈. Even though a line-of-sight distance d₅ to beacon device 420 is smallest, a travelling distance d₈ to beacon device 540 is shortest. When determining which beacon device to communicate with, a travelling distance to each beacon device is determined without considering a line-of-sight distance.

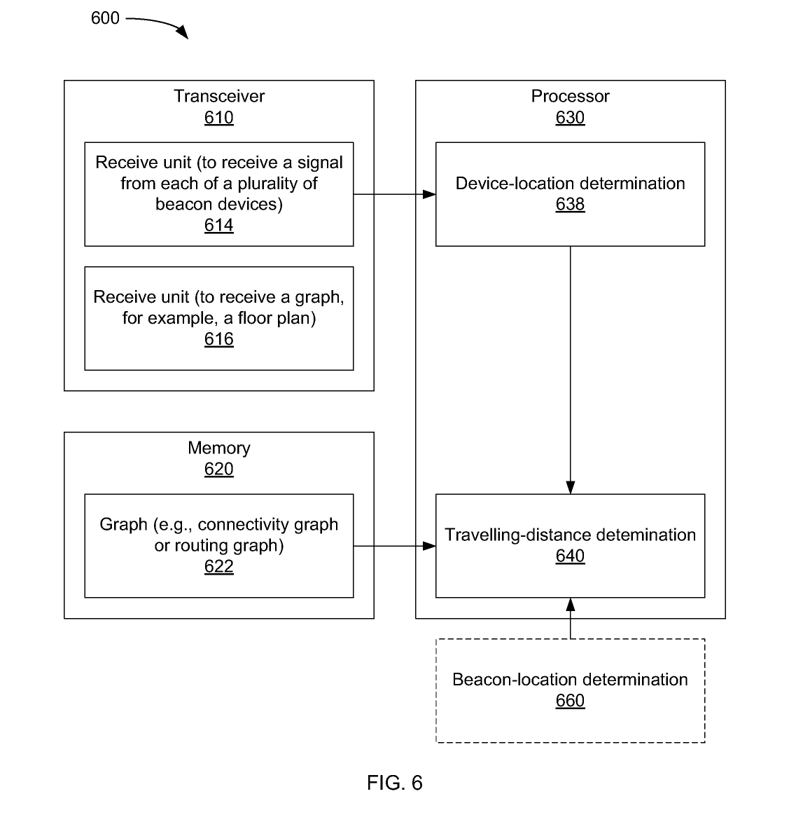

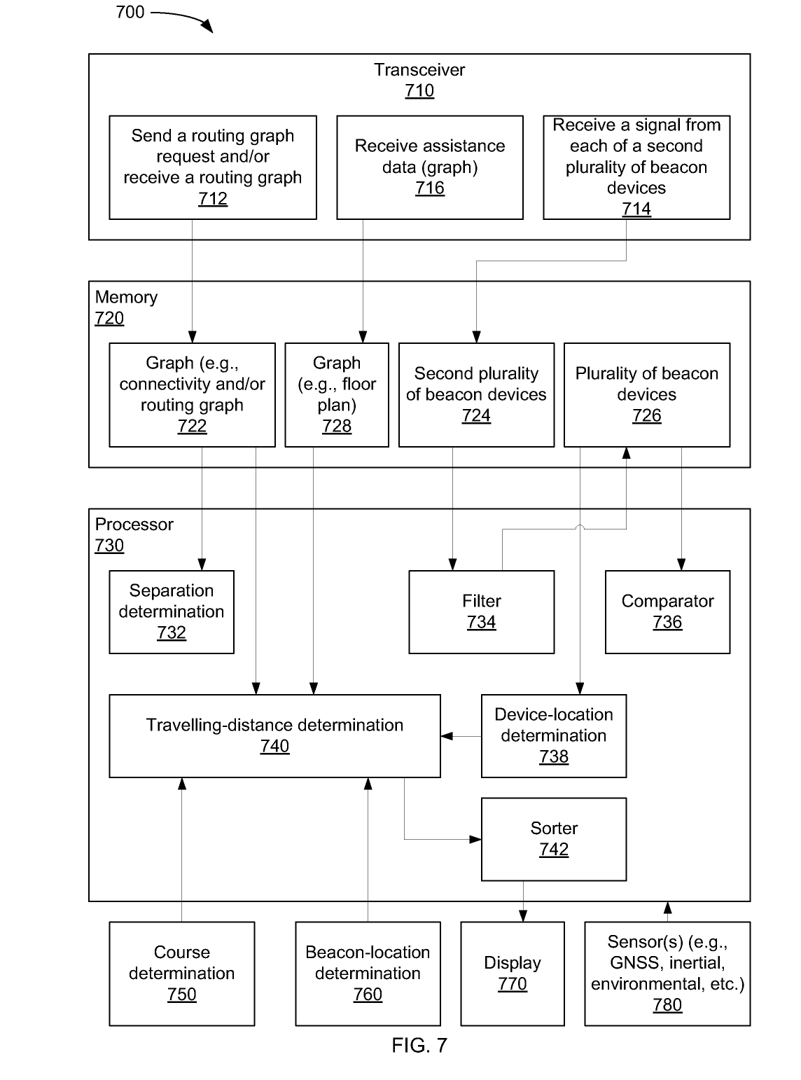

FIGS. 6 and 7 illustrate a mobile device, in accordance with some example embodiments.

In FIG. 6, a mobile device 600 includes a transceiver 610, memory 620 and a processor 630. Similarly, the shown mobile device 600 may represent a server remote from the mobile device. Hence, FIG. 6 may alternatively represent a server including a transceiver 610, memory 620 and a processor 630. The mobile device 600 also includes a beacon-location determination unit 660 indicated in a dashed box, which may optionally be part of the processor 630, reside in memory 620 or be a function on a remote server. The transceiver 610 includes a receive unit 614 and receive unit 616. The receive unit 614 is configured to receive a signal from a plurality of beacon devices. The receive unit 616 is configured to receive a graph (e.g., a floor plan, an electronic map, a connectivity graph, a routing graph, one or more electronic files indicative of an environment and/or the like). The receive unit 616 may receive the graph separately or as part of another message, such as an assistance data message. The receive units 614 and 616 may be implemented separately, as shown, or as a single unit.

The memory 620, in unit 622, may store various forms of assistance data and/or the like, including, for example, all or part of a graph and/or the like or some combination of graphs thereof. A connectivity graph may be resident in memory 620 before a process of determining a closest beacon device based on travelling distance. A connectivity graph may indicate how neighboring elements (such as nodes and edges) are connected or not connected together. Elements in a connectivity graph may, for example, form a one-meter by one-meter grid. A routing graph may be requested at various times, for example, if a connectivity graph is not already resident in memory 620. A routing graph is used to determine a shorted route between any two distant nodes, for example, using Dijkstra's algorithm. In certain instances, a routing graph requires less bandwidth to send and store than a connectivity graph.

The processor 630 includes a device-location determination unit 638 and a travelling-distance determination unit 640. The device-location determination unit 638 may act as a means for determining a location of the mobile device, and/or otherwise receive (e.g., via transceiver 610) signals from the plurality of beacon devices, and may determine a location of the mobile device 600. The location of the mobile device 600 may be determined by the mobile device 600 itself (e.g., using GPS, received signal strengths or signal round-trip time), one or more beacon devices (e.g. using signals received from the mobile device 600), a remote server (e.g., a location server), or a combination thereof (e.g., using assisted GPS).

The travelling-distance determination unit 640 may be coupled to the device-location determination unit 638 and the beacon-location determination unit 660. The travelling-distance determination unit 640 may be configured to compute a travelling distance between the mobile device 600 and the locations of the plurality of beacon devices based on a graph (e.g., a floor plan, an electronic map, a connectivity graph, a routing graph, one or more electronic files indicative of an environment and/or the like). The beacon-location determination unit 660 may act as a means for determining locations of a plurality of beacon devices and/or may otherwise be configured to determine locations of the plurality of beacon devices. A location of a beacon device currently transmitting may, for example, be determined based, at least in part, on a received signal that may be indicative of such a location. The beacon-location determination unit 660 may be executed within the processor 630 or may be derived from a table or database as determined by a remote server.

In FIG. 7, several optional features in an example mobile device 700. Example mobile device 700 includes a transceiver 710, memory 720 and a processor 730. Example mobile device 700 also includes a course determination unit 750, a beacon-location determination unit 760 and a display 770.

Example transceiver 710 includes a unit 712 to send a routing graph request and receive a routing graph in response. Unit 712 may act as a means for sending a routing graph request and/or a means for receiving a routing graph. Example transceiver 710 also includes a unit 714 to receive a signal from an initial plurality of beacon devices and/or a unit 716 to receive assistance data including a graph, such as a floor plan, an/or the like or some combination thereof. The initial plurality of beacon devices is later filtered down to a filtered plurality of beacon devices, for example, based, at least in part, on beacon type. For example, the initial plurality of beacon devices may contain a list of beacon devices for all beacon signals received but the filtered plurality of beacon devices may contain only the devices broadcasting a beacon type including a printer.

The memory 720 includes a graph unit 722 that may be used to store a graph, such as a connectivity graph or a routing graph, and/or the like, as described above. The memory 720 also includes a unit 724 that may be used to store a list of the initial plurality of beacon devices. Further, the memory 720 includes a unit 726 to hold a list of the filtered plurality of beacon devices. The memory 720 also includes a graph unit 728 to hold the graph (e.g., a floor plan, an electronic map, a connectivity graph, a routing graph, one or more electronic files indicative of an environment and/or the like).

Example processor 730 may comprise one or more processing units, which may provide a separation determination unit 732, a filter 734, a comparator 736, a device-location determination unit 738, a travelling-distance determination unit 740 and a sorter 742. Example separation determination unit 732 may determine whether an obstacle to navigation (e.g., a wall) separates the mobile device 700 from a beacon device of the plurality of beacon devices (either the initial plurality of beacon devices or the filtered plurality of beacon devices). By way of a non-limiting example, after receiving signals from the initial plurality of beacon devices, the filter 734 filters the initial plurality of beacon devices (e.g., based on a beacon type) to form the (filtered) plurality of beacon devices. For example, an initial list of beacon devices may be filtered down to just those beacon devices supporting one or more capabilities, services and/or products that may be of interest or use, e.g., printing.

Example comparator 736 may, for example, compare a count of the plurality of beacon devices received with a predetermined threshold number such that processing only continues when the count of the plurality of beacon devices is greater than and/or equal to the predetermined threshold number. Example device-location determination unit 738 may act as a means for: (1) determining a location of the mobile device; and/or (2) receiving signals (e.g., via transceiver 710) from the plurality of beacon devices.

Example travelling-distance determination unit 740 may compute a travelling distance between the mobile device 700 and the locations of the plurality of beacon devices based on the graph (e.g., the floor plan). In some examples, the graph is either a connectivity graph or a routing graph. Example sorter 742 may sort a plurality of beacon devices based on the travelling distance. The user and/or an application on the mobile device 700 may select a closest and/or otherwise particular beacon device based on the travelling distance to each beacon device. For example, a user may be present a list of the closest beacon devices based on a travelling distance and a beacon type (e.g., supporting a certain capability, service and/or product). The user may better to judge which beacon device is along an intended route or whether a detour is feasible.

Example course determination unit 750 may determine a course or direction of travel of the mobile device 700 from one or more sensor(s) 780 (e.g., a GNSS sensor, inertial sensor, an environmental sensor or other sensor). For example, course may be determined from a heading of a compass or be determined from one or more prior locations of the mobile device 700.

Example travelling-distance determination unit 740 may factor this course when computing a travelling distance. For example, a beacon device in front of a user, as determined by the course, may be favored over a closer beacon device behind a user. Presumable, because the user has already passed a beacon device, the user has already considered this passed-by beacon device. Also, a certain time and effort required to turn around to reach a beacon device positioned behind a user. For example, a user with a cart in a narrow isle way that has already passed a beacon device may need to take the cart to an open space before turning around and returning to the beacon device. In this manner, example travelling-distance determination unit 740 may compute a travelling distance based on a course of the mobile device 700. Example course determination unit 750 may be a function within the processor 730 or may be a separate hardware and/or software unit, such as a compass, within the mobile device 700.

Example beacon-location determination unit 760 may act as a means for determining locations of a plurality of beacon devices, and/or for determining a location for one or more of the plurality of beacon devices. Example beacon-location determination unit 760 may be a function within the processor 730 or may be received from a remote server from a table or other database. Example display 770 may visually display: (1) an indication of a travelling distance; (2) a beacon identifier for one or more of the plurality of beacon devices; (3) navigation information relating to one or more features; and/or (4) other like information from a graph and/or the like or some combination thereof, to a user. Additionally or alternatively, display 770 may take the form, at least in part, of an audio reproduction mechanism (e.g., a speaker, etc.) that may present an indication of: (1) a travelling distance; (2) a beacon identifier for one or more of the plurality of beacon devices; (3) navigation information relating to one or more features; and/or (4) other like information from a graph and/or the like or some combination thereof, to a user.

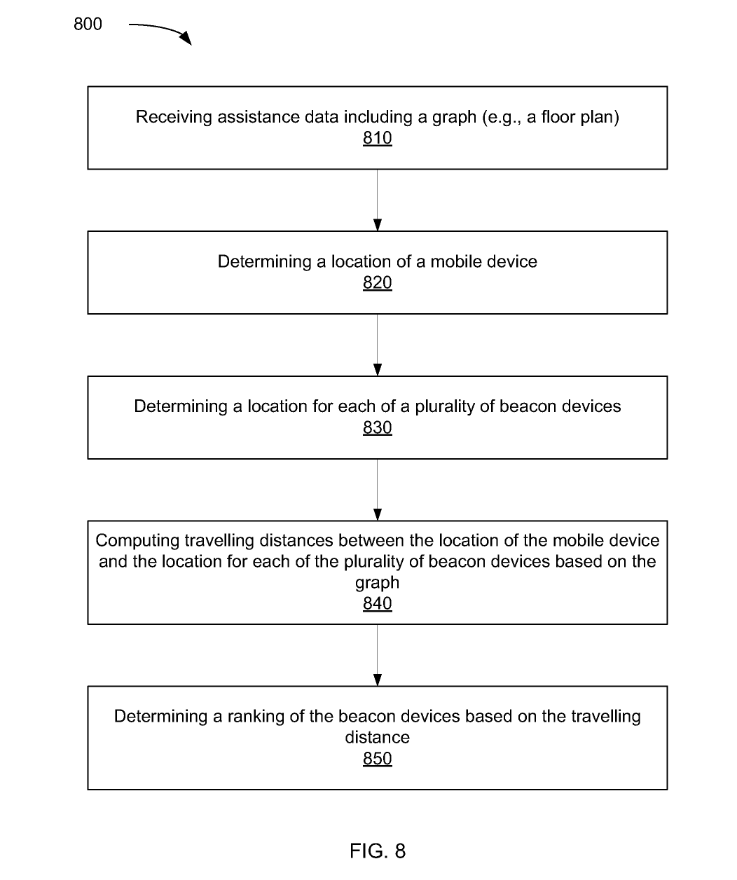

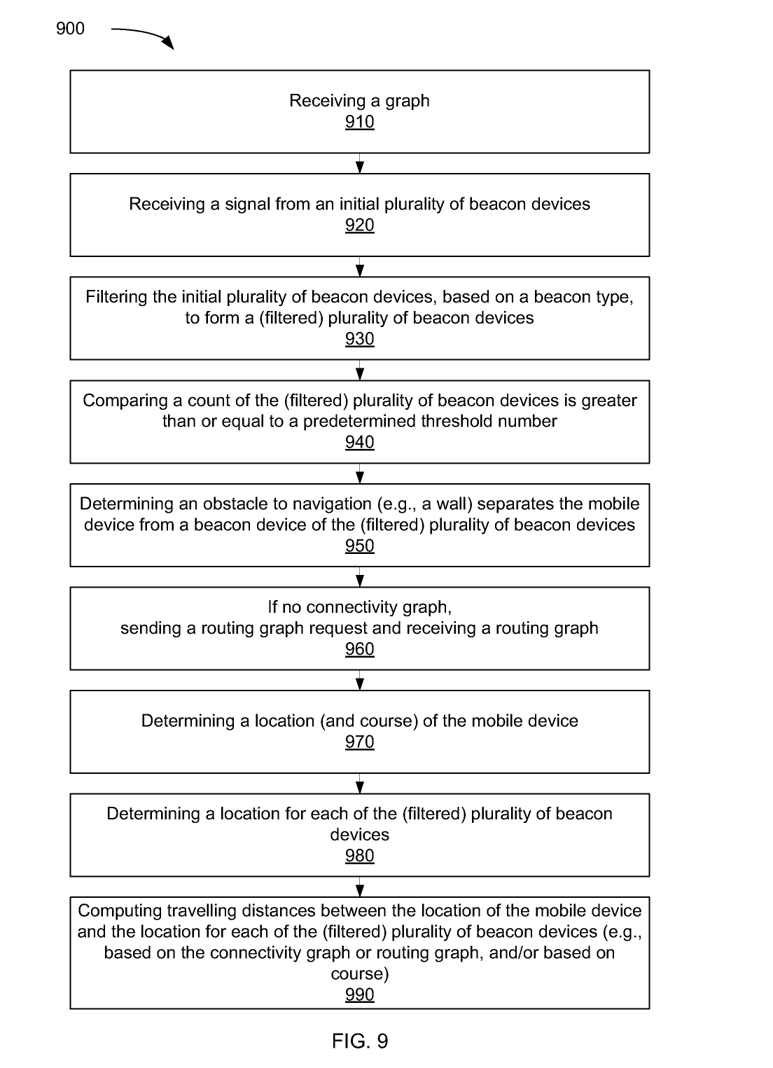

FIGS. 8 and 9 illustrate methods in a mobile device, in accordance with some example embodiments.

In FIG. 8, a method 800 in a mobile device (e.g., mobile device 600) for determining a beacon device is shown. At 810, the mobile device receives assistance data including a graph, such as a floor plan, from a remote server. The remote server may be an Assistance Data Server, a Location Server, or the like.

At 820, the mobile device determines a location of the mobile device. As shown here, the assistance data may be used by the mobile device to determine a location. Alternatively, the assistance data may be used by the mobile device to assist the network in determining a location for the mobile device.

At 830, the mobile device determines locations of a plurality of beacon devices. Alternatively, the network determines or “knows” the location of one or more beacon devices, which may be communicated to the mobile device. For example, a network entity records the locations of the plurality of beacon devices.

At 840, the mobile device computes a travelling distance between the mobile device and the locations of the plurality of beacon devices based on the graph. Alternatively, a network entity, also referred to as a server remote from the mobile device, computes the travelling distance between the mobile device and the locations of the plurality of beacon devices based on the graph or other routing knowledge, table, formula or graph.

At 850, the mobile device sorts or ranks the beacon devices based on the travelling distance. In certain implementations, all or part of a sorting of an initial and/or a filtered plurality of beacon devices may be displayed to a user. An initial plurality of beacon devices may be all of the plurality of beacon devices by the mobile device or up to a predetermined number of beacon devices. In certain implementations, sorting of a plurality of beacon devices may be sent to one or more separate applications (on-board the mobile device and/or external to the mobile device on a remote server) for selection of a beacon device.

In FIG. 9, several optional boxes in method 900 are shown. At 910, a mobile device (e.g., mobile device 700) receives a graph (e.g., a floor plan, an electronic map, a connectivity graph, a routing graph, one or more electronic files indicative of an environment and/or the like) from a remote server. For example, the graph may be part of assistance data.

At 920, the mobile device receives a signal from an initial plurality of beacon devices. The received signals may require reception above a threshold quality or power level. The received signals may require communication to and from a beacon device and the mobile device.

At 930, the mobile device filters the initial plurality of beacon devices, e.g., based on a beacon type, to form a (filtered) plurality of beacon devices. For example, a beacon type may indicate a beacon is a printer, as advertisement, in the healthcare, fitness, security, and home entertainment industries, or the like.

At 940, the mobile device compares a count of the (filtered) plurality of beacon devices to a predetermined threshold number such that the count is greater than or equal to the predetermined threshold number. For example, if the predetermined threshold number has not yet been met, the mobile device repeats the process of receiving signals (step 920) and filtering (step 930) until the predetermined threshold number has been met.

At 950, the mobile device determines an obstacle to navigation (e.g., a wall, partition, long sofa, window, secured access way and/or the like) separates the mobile device from at least one beacon device of the plurality of beacon devices. The obstacle to navigation may or may not attenuate signals received from the beacon devices. The obstacle to navigation may make a direct journey difficult or impossible from the current location of the mobile device to a location of a particular beacon device.

At 960, the mobile device determines if a connectivity graph already exists. If no connectivity graph already exists, the mobile device sends a routing graph request and receives a routing graph from a remote server. A connectivity graph is used if the mobile device already contains the graph thereby requiring no further outside communication. That is, the connectivity graph contains all and more information than is needed. If no connectivity graph is available, a routing graph may be requested over requesting a connectivity graph because the routing graph may require less bandwidth to transmit and receive than a connectivity graph.

At 970, the mobile device determines a location of the mobile device. The mobile device may determine a course of the mobile device instead or in addition to a location. The mobile device may determine a location (and/or course): (1) by itself; (2) by receiving a location (and/or course) from a network; (3) by reading a message from a location server that determined the location of the mobile device; or (4) a combination thereof.

At 980, the mobile device determines locations of the plurality of beacon devices. The locations of the plurality of beacon devices may be determined by reading the graph by the mobile device. Alternatively, one or more locations may be recalled by a network entity. These locations may be forwarded to the mobile device, another network entity or used by the network entity.

At 990, the mobile device computes a travelling distance between the mobile device and the locations of the plurality of beacon devices, for example, based on the connectivity graph or routing graph and/or based on a course. Alternatively, a network entity computes a travelling distance between the mobile device and the location for at least one of the plurality of beacon devices, for example, based on the connectivity graph or routing graph and/or based on a course of the mobile device. In some example embodiments, the mobile device determines and communicates its course or heading. In other embodiments, the network entity determines the course of the mobile device. The travelling distance and course may be sorted and displayed to a user or provided to an application. The separate application may reside in the mobile device itself or may reside in a remote server.

A mobile device has been described above as: (1) receiving a graph; (2) determining a location of the mobile device; (3) determining locations of the beacon devices; (4) computing a travelling distance; and (5) sorting the beacon devices. One to all of these steps may be performed by one or more network entities. As such, the mobile device and the network may share or communicate one or more of the graph, the location of the mobile, the locations of beacon devices, the computed travelling distance(s) and/or the sorting.

Three examples follow but several more are possible wherein a device performing the method is either a mobile device or a network entity such as a server remote from the mobile device. In some embodiments, a mobile device may: (1) receive a graph; and (2) determine a location of a mobile device; while a network entity may: (3) determine locations of the beacon devices; and then the mobile device may: (4) compute a travelling distance. Alternatively, the network entity may: (1) receive a graph; (2) determine a location of a mobile device; (3) determine locations of the beacon devices; and then communicate this information to the mobile device. The mobile device may then: (4) compute travelling distances to one or more beacon devices. Alternatively, the network entity may: (1) receive a graph; (2) determine a location of a mobile device; (3) determine locations of the beacon devices; and then (4) compute a travelling distance. The network entity may then communicate the computed travelling distances to the mobile device. The computed travelling distances may be presents to a user or provided to an application.

The mobile device or network entity may perform these steps in the sequence presented, or may perform some or all of these steps triggered by the mobile device entering the graphed area, or in anticipation of a mobile device entering the graphed area. In some cases, the graph and the locations of the beacon devices may be predetermined or preloaded in the network entity. At a later time when a mobile device enters the graphed area, the mobile device and/or a network entity, separately or together, determines a location of the mobile device. Next, either the mobile device or the network entity computes a travelling distance. Finally, either the mobile device or the network entity may sort the beacon devices and present the top beacon device or the top beacon devices based on sorting to one or more applications on a server and/or the mobile device and/or to the user of the mobile device.

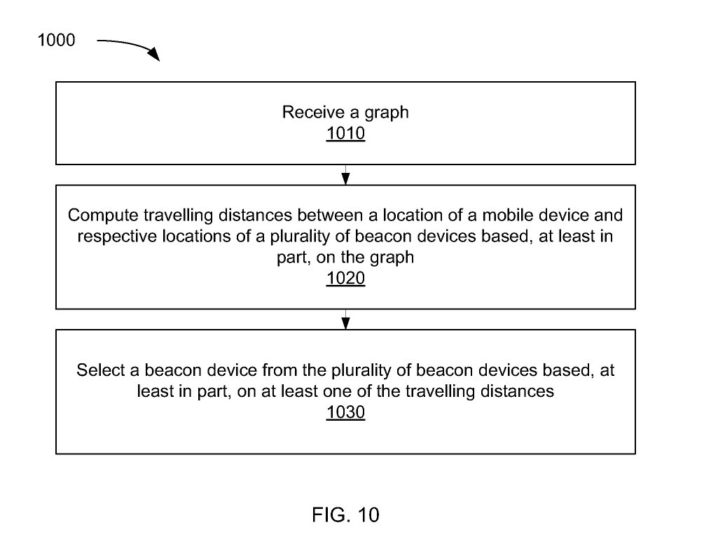

FIGS. 10, 11 and 12 illustrate methods for determining a beacon device, in accordance with some example embodiments.

In FIG. 10, a method 1000 may be performed by a mobile device or a server remote from the mobile device or both together. The device may include a transceiver and a processor. At 1010, the device receives a graph. The graph may be a floor plan, an electronic map, a connectivity graph, a routing graph, one or more electronic files indicative of an environment and/or the like. A transceiver in the device may act means for receiving a graph. At 1020, the device computes a travelling distance between a location of a mobile device and locations of a plurality of beacon devices based, at least in part, on the graph. A processor in the device may act as a means for computing a travelling distance between a location of a mobile device and locations of a plurality of beacon devices based, at least in part, on the graph. The means for computing the travelling distance may comprise a means for computing the travelling distance based, at least in part, on a direction of travel of the mobile device. At 1030, the device selects the beacon device based, at least in part, on the travelling distance. The device also may act as a means to select the beacon device based, at least in part, on the travelling distance.

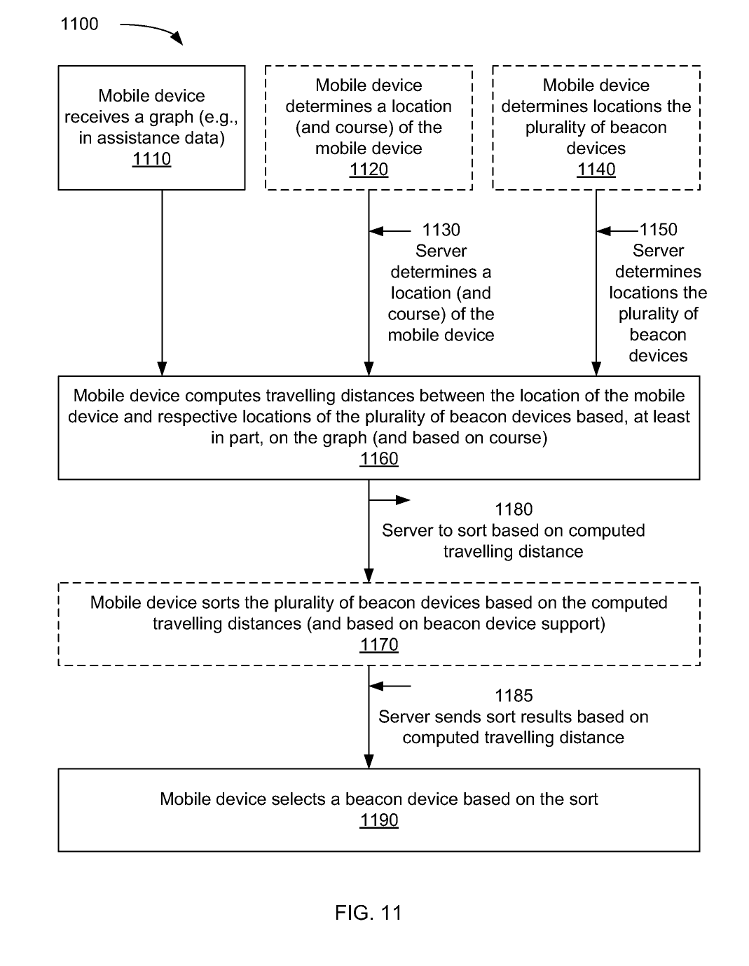

In FIG. 11, a method 1100 assumes the device is a mobile device. Optional steps are shown in dashed boxes. At 1110, a transceiver in the mobile device may receive a graph. For example, the mobile device may receive assistance data comprising the graph. The graph may comprise at least one of a connectivity graph and a routing graph, or the like.

At 1120, the mobile device may compute a location of the mobile device. Alternatively at 1130, the network may communicate the location of the mobile device to the mobile device. At 1140, the mobile device may determine locations of a plurality of beacon devices. Alternatively at 1150, the network may communicate the locations of the plurality of beacon devices to the mobile device.

At 1160, the mobile device computes a travelling distance between the location of a mobile device and the locations of the plurality of beacon devices based, at least in part, on the graph. For example, the mobile device may compute the travelling distance based, at least in part, on a direction of travel or course of the mobile device.

At 1170, the mobile device may sort the plurality of beacon devices based, at least in part, on the computed travelling distances and/or based, at least in part, on the plurality of beacon devices supporting a certain capability, service or product. At 1180 and 1185, the mobile device may communicate the computed travelling distances for a sort to the network and the network may reply with the sort results.

At 1190, the mobile device may select the beacon device based, at least in part, on the sort or the travelling distance. The network and/or the mobile device may provide the beacon device to an application.

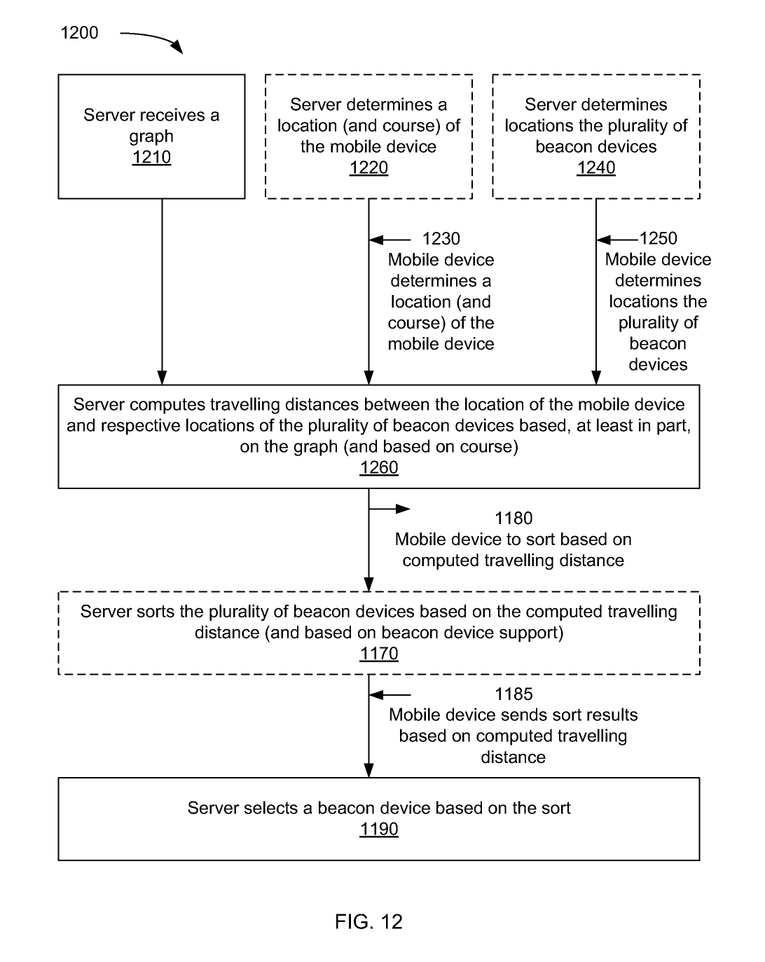

In FIG. 12, a method 1200 assumes the device is a server. Again, optional steps are shown in dashed boxes. At 1210, the server receives a graph. For example, the server includes a transceiver configured to receive a graph. The graph may include a floor plan, an electronic map, a connectivity graph, a routing graph, one or more electronic files indicative of an environment and/or the like.

At 1220, the server may compute a location of the mobile device. Alternatively at 1230, the mobile device may communicate the location of the mobile device to the server. At 1240, the server may determine locations of a plurality of beacon devices. Alternatively at 1250, the mobile device may communicate the locations of the plurality of beacon devices to the server.

At 1260, the server computes a travelling distance between the location of a mobile device and the locations of the plurality of beacon devices based, at least in part, on the graph. For example, the server may compute the travelling distance based, at least in part, on a direction of travel or course of the mobile device.

At 1270, the server may sort the plurality of beacon devices based, at least in part, on the computed travelling distances and/or based, at least in part, on the plurality of beacon devices supporting a certain capability, service or product. At 1280 and 1285, the server may communicate the computed travelling distances for a sort to the mobile device and the mobile device may reply with the sort results.

At 1290, the server may select the beacon device based, at least in part, on the sort or the travelling distance. The server may provide the beacon device to an application.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A device comprising:
a transceiver configured to receive a graph; and
a processor coupled to the transceiver and configured to:
compute travelling distances between a location of a mobile device and respective locations of a plurality of beacon devices based, at least in part, on the graph; and
select a beacon device from the plurality of beacon devices based, at least in part, on at least one of the computed travelling distances.

2. The device of claim 1, wherein the processor is further configured to determine the location of the mobile device.

3. The device of claim 1, wherein the processor is further configured to determine the locations of the plurality of beacon devices.

4. The device of claim 1, wherein the processor is further configured to sort the plurality of beacon devices based, at least in part, on the computed travelling distances.

5. The device of claim 4, wherein the processor configured to sort the plurality of beacon devices is further based, at least in part, on the plurality of beacon devices supporting a capability, a service, a product, or a combination thereof.

6. The device of claim 4, wherein the processor is further configured to select the beacon device based, at least in part, on the sort.

7. The device of claim 6, wherein the processor is further configured to identify the beacon device to an application.

8. The device of claim 1, wherein the transceiver is further configured to receive assistance data comprising the graph.

9. The device of claim 1, wherein the processor is further configured to compute the travelling distances based, at least in part, on a direction of travel of the mobile device.

10. The device of claim 1, wherein the graph comprises a connectivity graph, a routing graph, or a combination thereof.

11. The device of claim 1, wherein the device comprises the mobile device.

12. The device of claim 1, wherein the device comprises a server remote from the mobile device.

13. A method comprising, at a device:
receiving an electronic file comprising a graph;
with a processor of the device, computing travelling distances between a location of a mobile device and respective locations of a plurality of beacon devices based, at least in part, on the graph; and
with the processor of the device, selecting a beacon device from the plurality of beacon devices based, at least in part, on at least one of the computed travelling distances.

14. The method of claim 13, further comprising with the processor of the device, determining the locations of the plurality of beacon devices.

15. The method of claim 13, further comprising with the processor of the device, sorting the plurality of beacon devices based, at least in part, on the computed travelling distances.

16. The method of claim 15, wherein sorting the plurality of beacon devices is further based, at least in part, on the plurality of beacon devices supporting a capability, a service,a product, or a combination thereof.

17. The method of claim 13, further comprising at the device receiving assistance data comprising the graph.

18. The method of claim 13, wherein computing the travelling distances further comprises, with the processor of the device, computing the travelling distances based, at least in part, on a direction of travel of the mobile device.

19. A device comprising:
means for receiving a graph;
means for computing travelling distances between a location of a mobile device and respective locations of a plurality of beacon devices based, at least in part, on the graph; and
means for selecting a beacon device from the plurality of beacon devices based, at least in part, on at least one of the computed travelling distances.

20. The device of claim 19, wherein the means for computing the travelling distances comprises means for computing the travelling distances based, at least in part, on a direction of travel of the mobile device.
